(19) United States
(12) Patent Application Publication
(10) Pub. No.: US 2026/0220282 A1
(43) Pub. Date: Jul. 30, 2026

(54) SYSTEMS AND METHODS FOR ISSUING COMPREHENSIVE SOFTWARE IDENTITIES FOR MULTIPLE COMPUTE DOMAINS CONFIGURED IN AN IHS

(71) Applicant: Dell Products L.P., Round Rock, TX (US)

(72) Inventors: Eugene David Cho, Austin, TX (US); Mukund P. Khatri, Austin, TX (US); Shyam T. Iyer, Cedar Park, TX (US)

(73) Assignee: Dell Products L.P., Round Rock, TX (US)

(21) Appl. No.: 19/040,130

(22) Filed: Jan. 29, 2025

(51) Int. Cl. G06F 21/60; G06F 21/57

(52) U.S. Cl. CPC G06F 21/604; G06F 21/57; G06F 21/602

(57) ABSTRACT

Systems and methods for issuing comprehensive software identities for multiple compute domains configured in an IHS that creates a new software identity construct (CSWID), which can holistically represent some, most, or all unique attributes of software are disclosed. According to one embodiment, an Information Handling System (IHS) may include multiple processors each comprising a compute domain. A first of the processors includes program instructions to, using an Initial Device Identifier (IDEVID) associated with a first of the compute domains, generate a first key derivation function (KDF) associated with one or more software elements of a second of the compute domains, and issue the KDF to the second compute domain, wherein the second compute domain uses the KDF to attest one or more applications configured on the first compute domain.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Cloud computing refers to a group of network elements providing services on demand, such as data storage and computing power, without directed active management by a user. Cloud computing relies on a sharing of resources to achieve coherence and economies of scale. Cloud computing can be provided as a service over the Internet, such as in the form of “Infrastructure as a Service” (IaaS), “Platform as a Service” (PaaS), and/or “Software as a Service” (SaaS). A Platform as a Service (PaaS) provider allows a consumer to deploy onto the PaaS cloud infrastructure consumer resources created using program language, libraries, services and tools supported by the PaaS provider. The consumer does not manage or control the underlying cloud infrastructure, including the networks, servers, operating systems, or storage, but has control over the deployed applications. Platform as a Service (PaaS) providers offer a computing platform, typically including an operating system, programming language execution environment, database, and web server, and the consumer, or user, develops and runs software on the cloud platform, rather than obtaining and maintaining the underlying hardware and software layers.

### SUMMARY

Systems and methods for issuing comprehensive software identities for multiple compute domains configured in an IHS that creates a new software identity construct (CSWID), which can holistically represent some, most, or all unique attributes of software are disclosed. According to one embodiment, an Information Handling System (IHS) may include multiple processors each comprising a compute domain. A first of the processors includes program instructions to, using an Initial Device Identifier (IDEVID) associated with a first of the compute domains, generate a first key derivation function (KDF) associated with one or more software elements of a second of the compute domains, and issue the KDF to the second compute domain, wherein the second compute domain uses the KDF to attest one or more applications configured on the first compute domain.

According to another embodiment, a comprehensive software identity issuing method includes the steps of using an Initial Device Identifier (IDEVID) associated with a first of a plurality of compute domains, generate a first key derivation function (KDF) associated with one or more software elements of a second of the compute domains, and issue the KDF to the second compute domain, wherein the second compute domain uses the KDF to attest one or more applications configured on the first compute domain.

According to yet another embodiment, a non-transitory memory storage device has program instructions stored thereon that, upon execution by an Information Handling System (IHS), causes the IHS to using an Initial Device Identifier (IDEVID) associated with a first of the compute domains, generate a first key derivation function (KDF) associated with one or more software elements of a second of the compute domains, and issue the KDF to the second compute domain, wherein the second compute domain uses the KDF to attest one or more applications configured on the first compute domain.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 shows an example of an IHS that may be configured to implement embodiments of the present disclosure.

FIG. 2 illustrates an example comprehensive software identity issuing system showing how hardware-based comprehensive software identities (HW-CSWIDs) may be issued among the different compute domains in an IHS according to one embodiment of the present disclosure.

FIG. 3 illustrates an example comprehensive software identity issuing method 300 that may be used to issue comprehensive software identities among the different compute domains in an IHS according to one embodiment of the present disclosure.

FIG. 4 illustrates an example comprehensive software identity issuing method that may be performed to create a HW-CSWID for a compute domain according to one embodiment of the present disclosure.

FIGS. 5A-C illustrate example use cases in which trust may be distributed in an IHS having multiple different compute domains using the comprehensive software identity issuing system according to one embodiment of the present disclosure.

FIG. 6 illustrates yet another example in which a BMC can provide comprehensive software identities for an IHS throughout boot time and on into run time according to one embodiment of the present disclosure.

FIG. 7 illustrates yet another example use case in which a data control processor can provide comprehensive software identities for an IHS to provide a secure communication channel between a BMC and a host OS according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

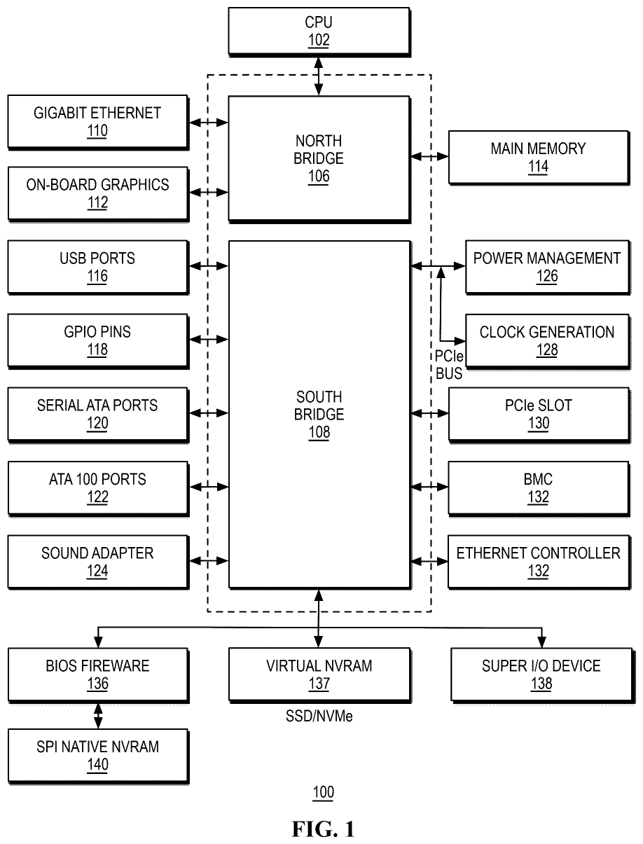

An IHS may include random access memory (RAM), one or more processing resources such as a central processing unit (CPU) or hardware or software control logic, ROM, and/or other types of nonvolatile memory. Additional components of an IHS may include one or more disk drives, one or more network ports for communicating with external devices as well as various input and output (I/O) devices, such as a keyboard, a mouse, touchscreen and/or a video display. An IHS may also include one or more buses operable to transmit communications between the various hardware components. A more detailed example of an IHS is described with respect to FIG. 1. It should be appreciated that although certain embodiments are discussed in the context of a personal computing device, other embodiments may utilize other types of IHSs.

Recently, cloud native workload authentication techniques have been developed to provide a security identity to each of multiple applications (e.g., workloads) running on an IHS. One example of such a workload authentication technique may include a Secure Production Identity Framework for Everyone (SPIFFE) protocol that may run a suitable agent, such as a SPIFFE runtime environment (SPIRE) on the IHS for attesting the workloads. Other workload authentication techniques may exist, such as OS for Crypto SWID, Linux OS (EL0-X) for UID/PID, and an external or local service for assigned unique software (e.g., APEX). These workload authentication techniques may provide a security identity (ID) to each of the workloads and enable an individual application to identify and cryptographically authenticate other applications that it needs to communicate with, such as SPIFFE Verifiable Identity Documents (SVIDs) as used with SPIFFE compliant techniques. Additionally, the SPIFFE SPIRE agent may provide a workload API for any workload (e.g., application) that wants to leverage it.

Nevertheless, such workload Identity Frameworks (e.g., SPIFFE/SPIRE, etc.) usually derive software tokens or identities with no connection to the hardware on which the workload is executed on. They are purposefully done this way in order to maximize mobility and flexibility. Other technologies such as measured boot and DICE aim to derive application identities purely off boot time measurements with Unique-per-device secret. But these technologies provide no connection to build time/update measurements.

An IHS may initially be assigned with an initial device identity (IDEVID) at the factory when it is assembled/manufactured. Once verified, such as by a management entity, The IHS may, per the 802.1AR specification, be assigned with a local device identity (LDEVID), which is better suited for secured channel (i.e. TLS) communication as it supports better certificate/key management practices (e.g., revocation, rotation, etc.) compared to the IDEVID from the manufacturer, due to being long lived.

Many IHSs nowadays are configured with multiple processors (e.g., CPUs, GPUs, etc.) that each form their own individual compute domains. Such disaggregation also results in the disaggregation of customer trust between the Host CPU and various xPUs (e.g., IPU, DPU, GPU, DPU, data control processor, etc.). Each compute domain usually has a Trusted Execution Environment (TEE) or Enclave.

Current Attestation and Secured/Encrypted Communication Protocols (e.g., SPDM, TEE Attestation, etc.) utilize long-lived hardware identities that are typically configured during manufacturing. Nevertheless, utilizing a single key for long periods of time without easy revocation, rotation is not a good security practice. Software identities are better suited for these protocols and can scale better across multiple software/applications across multiple CPUs, but this has challenges. Build time derived software identities (i.e., SBOM, Package signatures) do not accurately reflect runtime software. Runtime/Boot time derived software identities (e.g., DICE Alias, TPM PCRs, etc.) do not accurately reflect build time software. As these models typically rely on aggregation of one-way functions (e.g., hashes for PCR, HMAC for DICE, etc.), real-time compute workload movement between compute domains often requires those software identities to be reassignable on demand.

As will be described in detail herein below, embodiments of the present disclosure provide a system and method for issuing comprehensive software identities for multiple compute domains configured in an IHS that creates a new software identity construct (CSWID), which can holistically represent all unique attributes of software, including the hardware it is expected to run on, the expected Trusted Computing Base (TCB) (e.g., boot time measurements), the ingredients that go into the software (e.g., build time measurements), and any additional unique per application configurations.

FIG. 1 shows an example of an IHS 100 that may be configured to implement embodiments of the present disclosure. It should be appreciated that although certain embodiments described herein may be discussed in the context of a desktop or server computer, other embodiments may be utilized with virtually any type of IHS 100. Particularly, the IHS 100 includes a baseboard or motherboard, to which is a printed circuit board (PCB) to which components or devices are mounted by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100. Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS 100 (e.g., a remotely located IHS 100) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 116, sound adapter 124, Ethernet controller 134, and one or more general purpose input/output (GPIO) pins 118. Southbridge 108 may also provide a bus for interfacing peripheral card devices such as PCIe slot 130. In some embodiments, the bus may include a peripheral component interconnect (PCI) bus. Southbridge 108 may also provide baseboard management controller (BMC) 132 for use in managing the various components of the IHS 100. Power management circuitry 126 and clock generation circuitry 128 may also be utilized during operation of southbridge 108.

Additionally, southbridge 108 is configured to provide one or more interfaces for connecting mass storage devices to the IHS 100. For instance, in one embodiment, southbridge 108 may include a serial advanced technology attachment (SATA) adapter for providing one or more serial ATA ports 120 and/or an ATA100 adapter for providing one or more ATA100 ports 122. Serial ATA ports 120 and ATA100 ports 122 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 130, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 136 that includes BIOS program code containing the basic routines that help to start up the IHS 100 and to transfer information between elements within the IHS 100. BIOS/firmware 136 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 136 to store configuration data for the IHS 100. In other embodiments, configuration data for the IHS 100 may be stored on the same virtual NVRAM 137 as BIOS/firmware 136. The IHS 100 may also include a SPI native NVRAM 140 coupled to the BIOS 136.

BMC 132 may include non-volatile memory having program instructions stored thereon that enable remote management of the IHS 100. For example, BMC 132 may enable a user to discover, configure, and manage the IHS 100, setup configuration options, resolve and administer hardware or software problems, and the like. Additionally or alternatively, BMC 132 may include one or more firmware volumes, each volume having one or more firmware files used by the BIOS' firmware interface to initialize and test components of the IHS 100.

As a non-limiting example of BMC 132, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

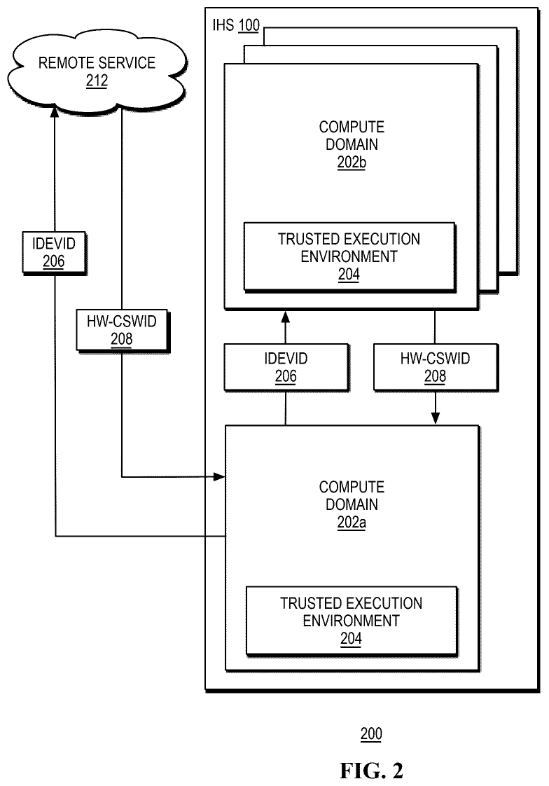

FIG. 2 illustrates an example comprehensive software identity issuing system 200 showing how hardware-based comprehensive software identities (HW-CSWIDs) may be issued among the different compute domains in an IHS 100 according to one embodiment of the present disclosure. The IHS 100 includes one or more compute domains 202a-b (collectively 202) that may be formed by multiple different xPUs (e.g., IPU, DPU, GPU, DPU, data control processor, etc.). Each xPU is configured with a Trusted Execution Environment (TEE) 204 or any other suitable trusted isolated compute entity that when configured in the IHS 100 during its assembly/fabrication, is configured with an initial device identifier (IDEVID) 206, which is a long-lived certificate.

When the compute domain 202a wishes to attest to a compute domain 202b, it provides the IDEVID 206 to the TEE 204 configured in compute domain 202b, which generates a HW-CSWID 208 and sends it to the requesting compute domain 202a. The HW-CSWID 208 may include a KDF generated according to the hardware it is expected to run on, the expected Trusted Computing Base (TCB) (e.g., boot time measurements), the ingredients that go into the software (e.g., build time measurements), and any additional unique per application configuration information. In another embodiment, the compute domain 202a mat attest to a remote service 212, it may provide another IDEVID 206 to the remote service 212, which generates a HW-CSWID 208 and sends it to the requesting compute domain 202a. The remote service 212, for example, may be one that is configured in a management interface within in a data center.

While the IDEVID 206 is long-lived, the HW-CSWID 208 is issued whenever there is a change in software (e.g., update, workload migration, etc.) in that compute domain 202a. The HW-CSWID 208 allows software running on the compute domain 202a or TEE 204, use shorter lived software identity keys which are binded to the hardware. These shorter lived keys can be used for secured communication (i. e, TLS) between compute domains 202. While deriving Software Identities, service can take into account from the subdomain runtime software/configuration measurements, such as PCR, Dice Alias, and the like from the compute domain 202a. The TEE 204 can also cross reference, from a backend database: hardware device identities (e.g., TEE, CPU), build-time software measurements (e.g., SBOM, etc.), and a manifest with expected configuration per application.

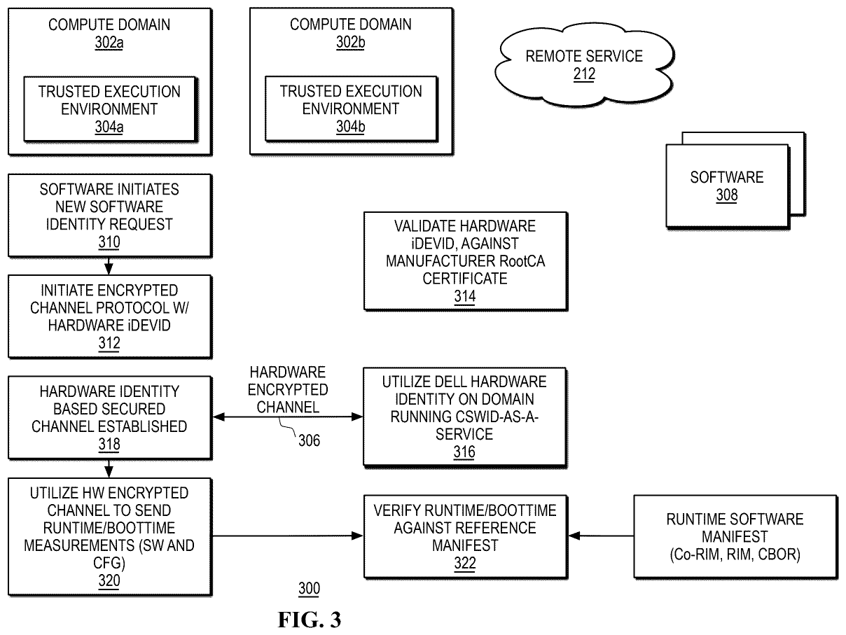

FIG. 3 illustrates an example comprehensive software identity issuing method 300 that may be used to issue comprehensive software identities among the different compute domains in an IHS 100 according to one embodiment of the present disclosure. Additionally or alternatively, the comprehensive software identity issuing 300 may be performed by the comprehensive software identity issuing system 200 as shown above with reference to FIG. 2. As shown, the TEE 304b in another compute domain 302b or a remote service 212 is used to issue the HW-CSWID 208. In another embodiment, an online service, such as an online support service managed by a vendor of the IHS 100 may be used to issue the HW-CSWID 208.

Initially at step 310, software running in the compute domain 302a initiates a new software identity request. The software may initiate the request at any time. In one embodiment, the software may initiate the request after the IHS 100 is booted and before the OS is allowed to gain access to the components in the IHS 100. Thereafter at step 312, the method 300 initiates an encrypted channel protocol with IDEVID 206 by sending it to the other compute domain 302b. The TEE 304b in the other compute domain 302b then validates the IDEVID 206 against the manufacturer (IHS vendor) root CA certificate at step 314. In this manner, the chain of trust may be extended all the way back to where the IHS 100 was initially assembled or manufactured. If the IDEVID 206 is validated against the manufacturer root CA certificate, the TEE 304b in the other compute domain 302b establishes a secure communication session 306, using the IDEVID 206, with the compute domain 302a at steps 316 and 318. Thereafter at step 320, the compute domain 302a sends runtime/boot time measurements to the TEE 304b in the other compute domain 302b, and at step 322, the TEE 304b in the other compute domain 302b runtime/boot time measurements. In one embodiment, the TEE 304b in the other compute domain 302b may access software and configuration databases 308 to verify the runtime/boot time measurements.

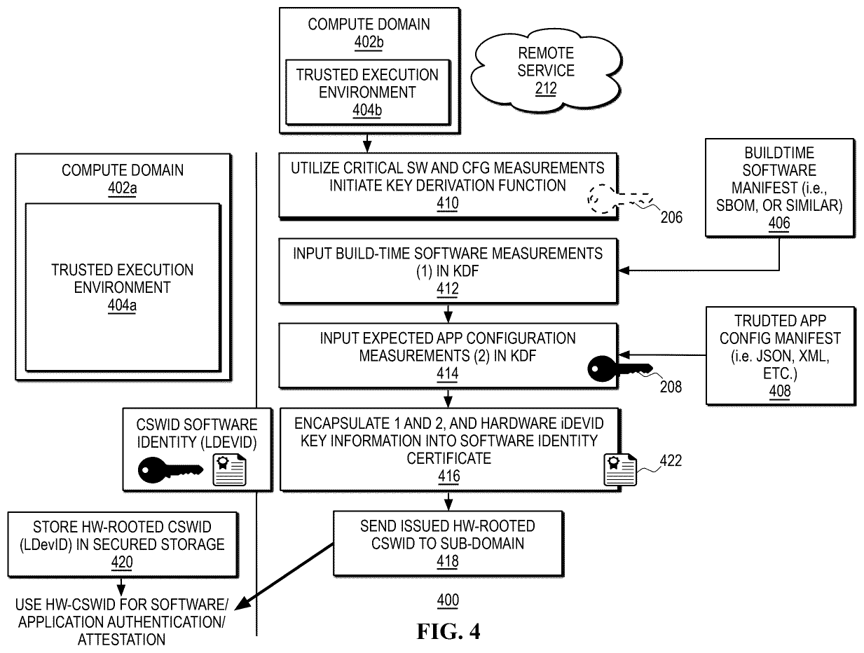

FIG. 4 illustrates an example comprehensive software identity issuing method 400 that may be performed to create a HW-CSWID 208 (e.g., golden measurements, etc.) for a compute domain 402a according to one embodiment of the present disclosure. Additionally or alternatively, the comprehensive software identity issuing 300 may be performed by the comprehensive software identity issuing system 200 as shown above with reference to FIG. 2. As shown, the TEE 304b in another compute domain 302b is used to issue the HW-CSWID 208. In another embodiment, an online service, such as an online support service managed by a vendor of the IHS 100 may be used to issue the HW-CSWID 208. The comprehensive software identity issuing method 400 may be performed at any suitable time, such as whenever a piece of software in the compute domain 402a is updated, or even when a configuration change is made to a piece of software.

At step 410, the compute domain 402b or the remote service 212 initiates a KDF 208 using software measurements. For example, the measurements may be based on the hardware it is expected to run on, the expected TCB (e.g., boot time measurements), the ingredients that go into the software (e.g., build time measurements), and any additional unique per application configurations. At step 412, the compute domain 402b inputs the build-time measurements that, for example, may be stored in a build-time database 406. At step 414, the compute domain 402b inputs the expected application configuration measurements, such as from a trusted app configuration manifest database 408.

The compute domain 402b then encapsulates the results of steps 412 and 414 to generate a certificate 422 at step 416. Thereafter at step 418, the compute domain 402b sends the HW-CSWID 208 to the compute domain 402a, in which the compute domain 402a stores the IDEVID 206 in a secured storage at step 420. At this point, the HW-CSWID 208 (e.g., golden measurements, etc.) has been generated and it could be used, for example, at the comprehensive software identity issuing method 300 of FIG. 3 to verify the software/firmware running on the compute domain 402a.

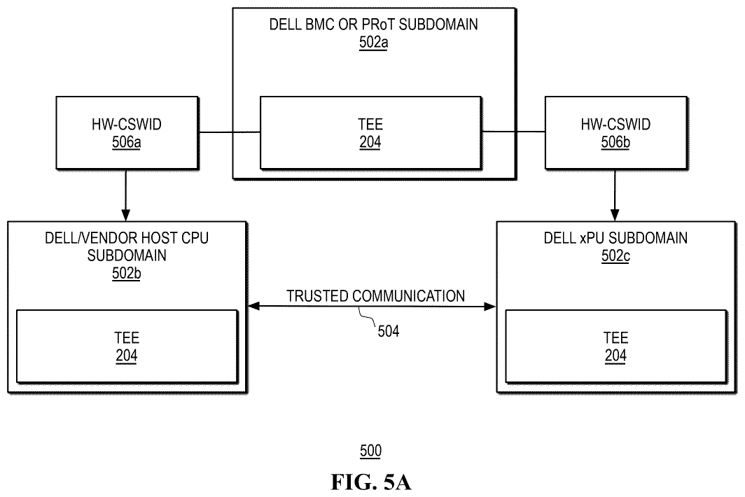

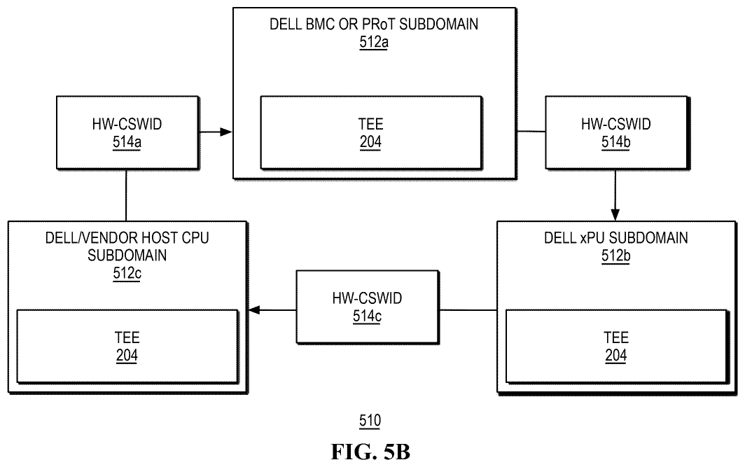

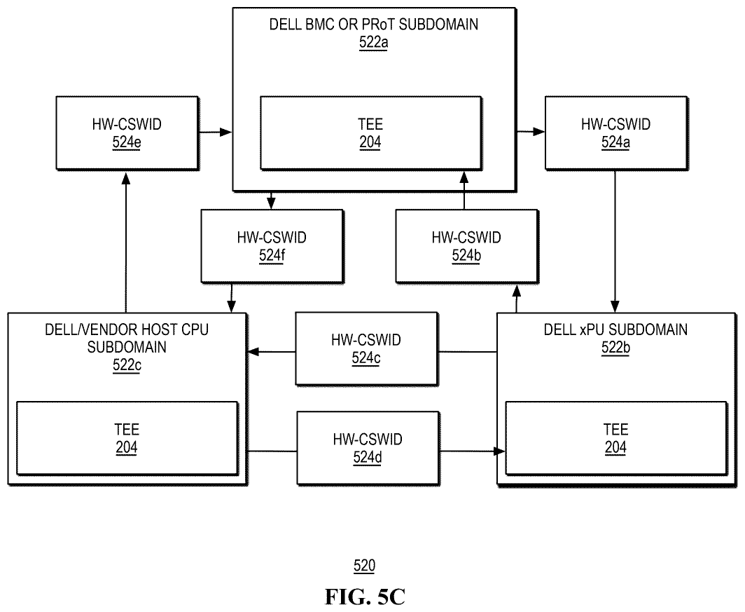

FIGS. 5A-C illustrate example use cases in which trust may be distributed in an IHS 100 having multiple different compute domains using the comprehensive software identity issuing system 200 according to one embodiment of the present disclosure. In particular, FIG. 5A illustrates a centralized use case 500 in which a first BMC compute domain 502a is used to issue a HW-CSWID 506a to each of a second host CPU compute domain 502b, and a HW-CSWID 506b to a third xPU compute domain 502c. Such a use case 500 may be useful when the first compute domain 502a possesses a relatively higher level of trust than the other compute domains 502b-c. Once the trust with each compute domain 502b-c has been established, a secure trusted communication path 504 may be established between the CPU compute domain 502b and xPU compute domain 502c so that they can securely communication with one another.

FIG. 5B illustrates another use case 510 in which trust between compute domains can be considered to be at least somewhat circular in that a first BMC compute domain 512a issues a HW-CSWID 514a to a second xPU compute domain 512b, the second xPU compute domain 512b issues a HW-CSWID 514b to a third host CPU compute domain 512c, while the third host CPU compute domain 512c issues a HW-CSWID 514c to the first BMC compute domain 512a. Such a use case 510 may be useful for scenarios in which all compute domains 510 have a generally equivalent amount of trust.

FIG. 5C illustrates yet another use case 520 in which the TEE 204 in a first BMC compute domain 522a issues a HW-CSWID 524a to a second xPU compute domain 522b, while a TEE 204 in the second xPU compute domain 522b issues a HW-CSWID 524b to the first BMC compute domain 522a. Also, the TEE 204 in the second xPU compute domain 522b issues a HW-CSWID 524c to a third host CPU compute domain 522c, while a TEE 204 in the third host CPU compute domain 522c issues a HW-CSWID 524d to the second xPU compute domain 522b. Additionally, the TEE 204 in the third host CPU compute domain 522c issues a HW-CSWID 524e to the first BMC compute domain 522a, while the TEE 204 in the first BMC compute domain 522a issues a HW-CSWID 524f to the third host CPU compute domain 522c. Such a use case 520 may be useful for scenarios in which the trust level may vary between each compute domain 522a-c and the TEE 204 within each compute domain 522a-c. Also, the use case 520 may be particularly useful for secure communication among the different compute domains 522a-c.

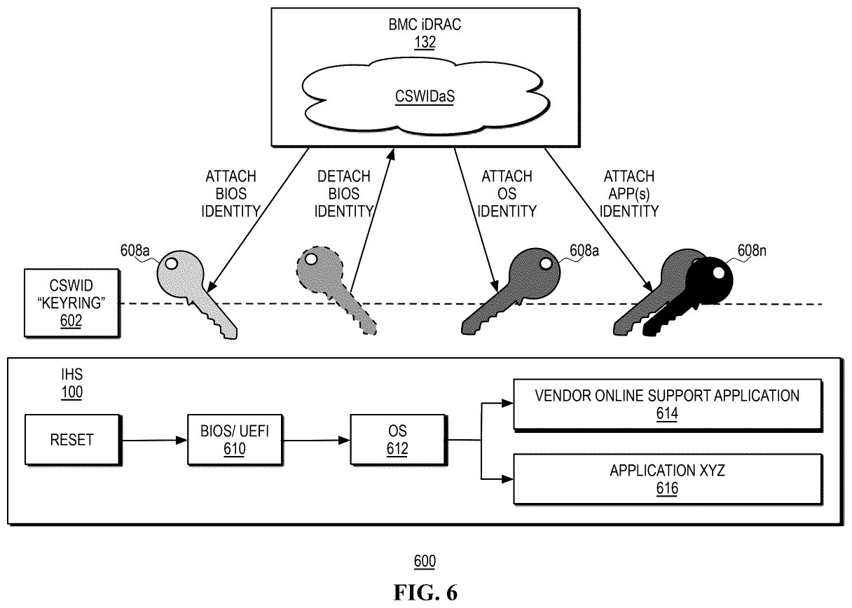

FIG. 6 illustrates yet another example use case 600 in which a BMC 132 can provide comprehensive software identities for an IHS throughout boot time and on into run time according to one embodiment of the present disclosure. In this particular example, the BMC 132 may function as a comprehensive software identities as a service to manage a keyring 602 that includes HW-CSWID 608a-n (collectively 608) for ensuring the integrity of the bios/UEFI 610 during boot time and/or the host OS 612 during run time. For example, the BMC 132 may issue a HW-CSWID 608a that is attached during boot time and detached when boot up has completed. When the host OS 612 is started, the BMC 132 may attach another HW-CSWID 608b to the host OS 612. Further, when a vendor online support application 614 or any other application is launched on the host OS 612 is started, the BMC 132 may issue HW-CSWIDs 608n for those applications. In one embodiment, the vendor online support application 614 may communicate with a vendor online support portal to perform remote attestation of the BMC 132 so that the trust level of the BMC 132 may be enhanced.

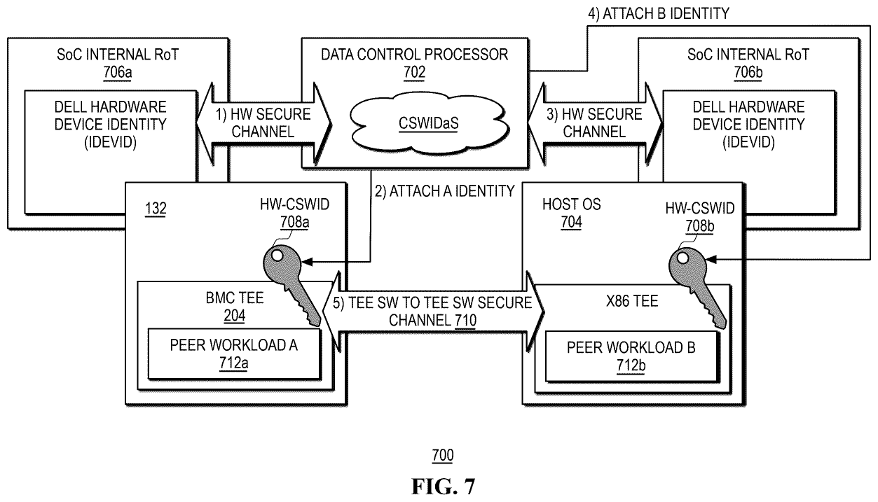

FIG. 7 illustrates yet another example use case 700 in which a DPU (e.g., data control processor) 702 can provide comprehensive software identities for an IHS to provide a secure communication channel between a BMC 132 and a host OS 704 according to one embodiment of the present disclosure. In this particular example, the DPU 702 may function as a comprehensive software identities as a service to issue HW-CSWIDs 708a-b (collectively 708) for each of the BMC 132 and host OS 704. For example, the DPU 702 may use an IDEVID 706a to issue a HW-CSWID 708a that is attached to a BMC 132, and use a IDEVID 706b to issue a HW-CSWID 708b that is attached to a host OS 704. After this point, the BMC 132 and host OS 704 may use that binding to create a secure communication channel 710 so that a workload 712a running on the BMC 132 can securely communicate with a workload 712b running on the host OS 704.

Although FIGS. 4 through 7 describe how hardware-based comprehensive software identities (HW-CSWIDs) may be issued among the different compute domains in an IHS 100, the features of the process may be embodied in other specific forms without deviating from the spirit and scope of the present disclosure. For example, the process may perform additional, fewer, or different operations than those described in the present examples. For another example, the process may be performed in a sequence of steps different from that described above. For yet another example, the process may be performed by components other than what is described herein above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterward be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a plurality of processors each comprising a compute domain;
a first of the processors comprising program instructions stored in a memory that, upon execution by the first processor, cause the IHS to:
using an Initial Device Identifier (IDEVID) associated with a first of the compute domains, generate a first key derivation function (KDF) associated with one or more software elements of a second of the compute domains; and
issue the KDF to the second compute domain, wherein the second compute domain uses the KDF to attest one or more applications configured on the first compute domain.

2. The IHS of claim 1, wherein the program instructions, upon execution by the host processor, further cause the IHS to generate the KDF using a Trusted Execution Environment (TEE) in the first processor.

3. The IHS of claim 1, wherein the program instructions, upon execution by the host processor, further cause the IHS to generate the KDF using a remote vendor service.

4. The IHS of claim 1, wherein the software elements comprise at least one of a hardware that the software elements are expected to run on, one or more expected boot time measurements, one or more build time measurements, and any additional unique per application configurations.

5. The IHS of claim 1, wherein the first compute domain comprises a Baseboard Management Controller (BMC).

6. The IHS of claim 5, wherein the program instructions, upon execution by the host processor, further cause the BMC to issue another KDF to a third compute domain, wherein the second compute domain and the third compute domain form a secure communication channel using their issued KDFs.

7. The IHS of claim 1, wherein the first compute domain comprises a Data Processing Unit (DPU).

8. A comprehensive software identity issuing method comprising:
using an Initial Device Identifier (IDEVID) associated with a first of a plurality of compute domains, generate a first key derivation function (KDF) associated with one or more software elements of a second of the compute domains; and
issue the KDF to the second compute domain, wherein the second compute domain uses the KDF to attest one or more applications configured on the first compute domain.

9. The comprehensive software identity issuing method of claim 8, further comprising generating the KDF using a Trusted Execution Environment (TEE) in the first processor.

10. The comprehensive software identity issuing method of claim 8, further comprising wherein the program instructions, upon execution by the host processor, further cause the IHS to generate the KDF using a remote vendor service.

11. The comprehensive software identity issuing method of claim 8, further comprising wherein the software elements comprise at least one of a hardware that the software elements are expected to run on, one or more expected boot time measurements, one or more build time measurements, and any additional unique per application configurations.

12. The comprehensive software identity issuing method of claim 8, wherein the first compute domain comprises a Baseboard Management Controller (BMC).

13. The comprehensive software identity issuing method of claim 12, further comprising issuing another KDF to a third compute domain, wherein the second compute domain and the third compute domain form a secure communication channel using their issued KDFs.

14. A non-transitory memory storage device having program instructions stored thereon that, upon execution by an Information Handling System (IHS), cause the IHS to:
using an Initial Device Identifier (IDEVID) associated with a first of the compute domains, generate a first key derivation function (KDF) associated with one or more software elements of a second of the compute domains; and
issue the KDF to the second compute domain, wherein the second compute domain uses the KDF to attest one or more applications configured on the first compute domain.

15. The non-transitory memory storage device of claim 14, wherein the program instructions, upon execution by the host processor, further cause the IHS to generate the KDF using a Trusted Execution Environment (TEE) in the first processor.

16. The non-transitory memory storage device of claim 14, wherein the program instructions, upon execution by the host processor, further cause the IHS to generate the KDF using a remote vendor service.

17. The non-transitory memory storage device of claim 14, wherein the software elements comprise at least one of a hardware that the software elements are expected to run on, one or more expected boot time measurements, one or more build time measurements, and any additional unique per application configurations.

18. The non-transitory memory storage device of claim 14, wherein the first compute domain comprises a Baseboard Management Controller (BMC).

19. The non-transitory memory storage device of claim 18, wherein the program instructions, upon execution by the host processor, further cause the BMC to issue another KDF to a third compute domain, wherein the second compute domain and the third compute domain form a secure communication channel using their issued KDFs.

20. The non-transitory memory storage device of claim 14, wherein the first compute domain comprises a Data Processing Unit (DPU).
